(19) United States
(12) Patent Application Publication
(10) Pub. No.: US 2008/0040771 A1
(43) Pub. Date: Feb. 14, 2008

(54) Device, System and Method for the Presentation of a Signal Having an Audio-Visual Content

(76) Inventors: Yan-Mei Tang Talpin, Saint Gregoire (FR); Alain Durand, Rennes (FR); Olivier Heen, Domloup (FR)

Correspondence Address: THOMSON LICENSING LLC, Two Independence Way, Suite 200, PRINCETON, NJ, 08540, US

(21) Appl. No.: 11/667,216

(22) PCT Filed: Nov. 9, 2005
(86) PCT No.: PCT/FR05/02796

§ 371 Date: May 7, 2007

(30) Foreign Application Priority Data
Nov. 10, 2004 (FR) 0411996

(51) Int. Cl. H04N 7/16

(52) U.S. Cl. 725/136

(57) ABSTRACT

A device for presentation of a signal having an audio-visual content, comprising means for presenting said content, means for connecting to a transmission channel which is external with respect to said device for receiving a signal, and a module for transmission of a signal which is disposed in the same container together with the presentation means, comprising means for storing a first identification information, adapted to receive the signal from the connection means and to transmit said signal to the presentation means only when the first identification information corresponds to a second identification information contained in the signal. A system and method for presenting a signal comprising an audio-visual content are also disclosed.

The present invention relates to a device, a system and a method of presenting a signal containing audiovisual content.

In particular, the invention relates to a device for presenting a signal containing audiovisual content, presentation means of this content and connection means to a transmission channel external to the device, for the reception of the signal.

Audiovisual content providers restrict the broadcast of these signals to defined geographical areas. For example, in some states of the United States, the broadcast of a hockey match is limited to a geographical area located beyond a perimeter of 100 kilometres of the stadium in which the game is played.

For this purpose, it is known how to broadcast audiovisual signals by satellite over delimited geographic areas or to transmit authorised broadcast geographic zone information in the audiovisual signals transmitted by cable.

An access device, for example a decoder unit, connected upstream of a presentation device, receives these signals and checks whether the information of the authorised broadcast zone is in its memory. When this information matches, the access device processes the audiovisual signal and transmits it to the presentation device.

Hence, the document WO 03/088664 describes a device suitable for comparing an authorised geographic zone information stored in a memory with a geographic zone information contained in the memory and for sending the signal to a screen when the two information elements match.

However, this device is unreliable as it is possible to verify the authorised broadcast zone within a zone perimeter, then send the signal to a remote screen located in another geographic zone, for example by transmission over a long distance network.

The purpose of the invention is to propose a presentation device inhibiting the presentation of audiovisual content when this content is not intended to be broadcast in the geographic area of the presentation device.

To this purpose, the purpose of the invention is a presentation device of the abovementioned type, characterized in that it comprises:

a transmission module of the signal mounted in the same container as the presentation means and comprising storage means of a first identification information, the transmission module being suitable for receiving the signal from the connection means and for transmitting it to the presentation means only if the first identification information agrees with a second identification information contained in the signal.

According to particular embodiments, the presentation device has one or more of the following characteristics:

the second identification information comprises an authorised broadcast geographic zone information,

the second identification information contained in the signal received by the presentation device is protected, notably by encryption, against any modification,

the first identification information stored in the transmission module comprises the second identification information contained in the signal previously presented by the presentation means,

the transmission module also comprises:
means for reading the second identification information contained in the signal,
means for comparing the first identification information with the second identification information, and

specific monitoring means for transmitting to the presentation means the signal received by the connection means, when the first identification information agrees with the second identification information,

the monitoring means are suitable for replacing, a set number of times, the first identification information by the second identification information, when these elements of information do not match,

before the last replacement, the monitoring means is capable of sending to the presentation means a message containing a selection request between on the one hand, a last replacement of the first identification information and, on the other, the non-replacement of this first identification information, and

after the last replacement, the monitoring means is capable of sending to the presentation means a message informing the user that the content of the signal cannot be viewed when the second identification information does not match the first identification information.

The purpose of the invention is also a system for presenting an audiovisual content comprising an access device, a transmission channel of which one extremity is connected to the access device and a presentation device connected to the other extremity of the transmission channel, characterised in that:

the access device comprises the signal reception means, signal decoding means suitable for generating a decoded signal and means for sending the decoded signal to the presentation device, by means of the transmission channel and the presentation device is able to receive the decoded signal transmitted by the access device.

According to one particular embodiment, the system has the following characteristics:

the decoding means are suitable for preserving the second identification information contained in the signal or for reintroducing this information after this information is extracted for transmitting this information to the presentation device.

The purpose of the invention is also a presentation method of a audiovisual content characterized in that it comprises the following successive steps:

decoding of the signal by an access device, and

transmission of the decoded signal of the access device to the connection means of a presentation device, by a transmission channel external to the presentation device,

transmission of the decoded signal of the connection means to the presentation means contained in the presentation device, only if a second identification information included within the signal agrees with a first identification information stored in the storage means of the presentation device, and

display of the audiovisual content of the signal by the presentation means of the presentation device in the event that the transmission occurred during the previous stage.

The invention will be better understood from the following description, provided for information only and referring to the annexed drawings, wherein:

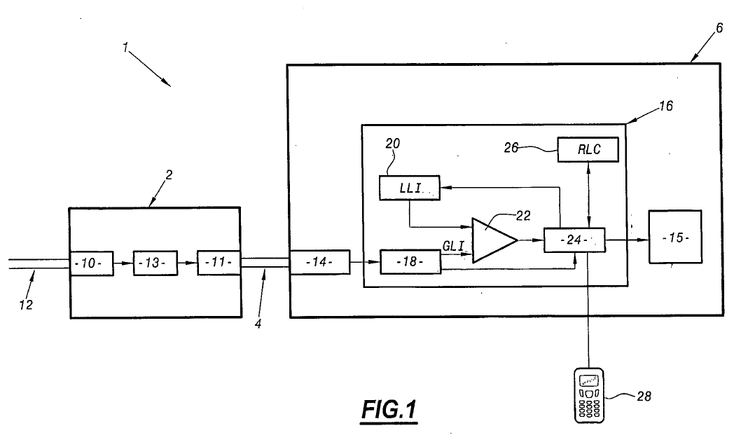

FIG. 1 is a diagrammatic view of a presentation system according to the invention, and

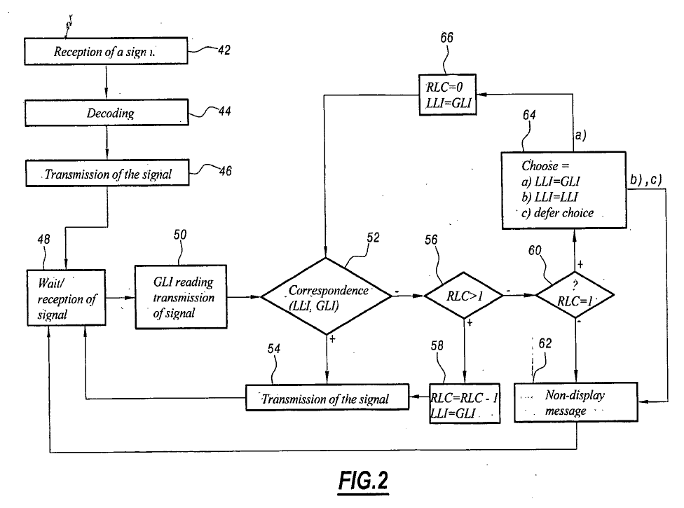

FIG. 2 is a flow chart of a presentation system according to the invention.

In the embodiment of the invention described, the audiovisual signal includes a main content such as an extract of music and/or a sequence of pictures as well as an authorised broadcast geographic zone information marked GLI.

This information includes, for example, a two-character code that represents a country, such as specified in a list of country codes defined in the standard ISO 3166-1: 1997. This information can be simple, such as a two-character code representing a geographical region or complex, such as a set of several codes or a code representing several countries such as for example the code “EP” for Europe, which corresponds to a set of different codes comprising notably “ES” for Spain and “IT” for Italy.

This authorised broadcast geographic zone information GLI is added to the main content to form the audiovisual signal, for example, by digital tattooing or preferentially, by being included in a license containing all the digital rights associated with the content.

It should be noted that the GLI information is transmitted in the content by being protected, notably by encryption, against any modification.

To ensure the integrity of the GLI information, this can notably be transmitted in an encrypted data packet, in a signed data packet or even in a data packet to which a data digest is attached, the digest being produced by the application of a data hash function.

The presentation system 1 of an audiovisual content according to the invention is shown diagrammatically on FIG. 1. This figure contains an access device 2, for example a digital decoder unit, a communication channel 4 and a presentation device 6, for example a digital television set.

The decoder unit 2 is the input source of any signal carrying content received by the system 1. For this purpose, the decoder 2 comprises a reception means 10 and transmission means 11 of the display signal, connected to a transmission line 12 and to the communication channel 4, respectively. The transmission line 12 is connected to an antenna receiving radio or “terrestrial” waves, to a digital network, or even to a satellite antenna. The audiovisual signal carried on the transmission line 12 includes the GLI information.

The access device 2 is suitable for decoding the display signals coming from different sources. For this purpose, it comprises a signal decoding means 13 connected, at the input, to the reception means 10 and, at the output, to the transmission means 11. The decoding means 13 is capable of decoding the digital signals received, as is known in the prior art.

The decoding means 13 is not suitable for checking the agreement between the information of the authorized broadcast geographic zone GLI contained in the signal received and a predefined zone.

Indeed, if this verification is carried out at the level of the decoder unit 2 in the presentation system 1, the verification will only be effective if the decoder 2 and the presentation device 6 are in the same place, or in any case, in the same geographic zone. If however, the access 2 and presentation 6 devices are located in different geographic zones, by using for example the Internet network as a communication channel 4, the GLI information can agree with the geographic zone of the decoder unit 2, but not agree with the zone of the digital television set 6 where the signal is displayed. Consequently, advantageously and according to the invention, the verification of the GLI information contained in the signal is carried out in the presentation device 6 of the signal.

After decoding, the transmission means 11 of the decoder unit therefore transmits to the digital television set 6 the decoded display signal but still comprising the GLI information. The GLI information is moreover sent in a protected manner so that the user of the presentation system 1 cannot fraudulently transform it to access a content from an unauthorised zone. For this purpose, the decoding means 13 is suitable for preserving the second GLI identification information contained in the signal or for reintroducing this GLI information after extracting this information for transmission of this information to the presentation device 6.

The communication channel 4 provides the link of the decoder unit 2 to the television set 6. It is constituted by all types of long distance transmission lines of digital data, such as for example an optical fibre, an asymmetric digital subscriber loop or on the contrary any type of short distance line such as for example a coaxial cable or a bus according to the IEEE 1394.1 standards.

The digital television set 6 is suitable for transforming the decoded display signal received from the channel 4 into an audiovisual content intended to be presented to a final user.

The television set 6 comprises connection means 14 to the channel 4, content presentation means 15 connected to a transmission module 16.

The connection means 14 are suitable for receiving the decoded display signal transmitted as required by the decoder unit 2, and for sending the signal to the transmission module 16.

The presentation means 15 are suitable for displaying and/or recovering the content of the decoded signal. It is formed for example by a screen and/or loudspeakers.

The transmission module 16 is capable of transmitting the decoded signal to the display means 15, only if a broadcast zone information element marked as LLI is identical to (for a simple country code) or corresponds to (for a complex country code) the GLI broadcast zone information contained in the signal.

For this purpose, the module 16 comprises reading means 18 connected to the connection means 14 and a memory 20.

The reading means 18 is capable of reading the authorised broadcast geographic zone information GLI contained in the signal or of extracting it for example by demultiplexing.

The memory 20 is suitable for storing the information of the LLI broadcast zone. The memory 20 comprises a non-volatile memory of the EEPROM type (Electrically Erasable Programmable Read Only Memory) or equivalent. It is blank during the first use of the television set 6, or comprises an LLI broadcast zone pre-recorded by the manufacturer of the television set 6.

The transmission module 16 also comprises comparison means 22, monitoring means 24 and a counter 26.

The comparison means 22 are suitable for comparing the GLI broadcast zone information contained in the decoded display signal with the LLI broadcast zone information recorded in the memory 20 and for supplying the monitoring means 24 with a validation signal when the GLI zone information agrees with the information of the LLI zone recorded in the memory 20.

For this purpose, the inputs of the comparison means 22 are connected to the reading means 18 and to the memory 20. The output of the comparison means 22 is connected to the monitoring means 24.

The monitoring means 24 are capable of authorising the transmission of the decoded display signal to the presentation means 15, on reception of the validation signal generated by the comparison means 22 and of inhibiting this transmission on reception of a non-validation signal generated by the comparison means 22.

The monitoring means 24 are connected to the reading means 18, to receive the display signal and to the presentation means 15, to transmit this signal to them.

In particular, the presentation means 15 is suitable for receiving the decoded display signal coming directly and only from the monitoring means 24. The connection between the monitoring means 24 and the presentation means 15 has no connection authorising the input of a decoded display signal.

Moreover, the monitoring means 24 is suitable for replacing the LLI broadcast zone information recorded in the memory 20 by the GLI broadcast zone information contained in the signal when these elements of information do not match. This replacement is made without the user intervening. It is however limited to a pre-defined maximum number of possible replacements which corresponds to the number of changes of authorized geographic zones.

For this purpose, the monitoring means 24 are therefore connected to the memory 20 and to an enumeration counter 26 of the number of authorised replacements remaining RLC.

This counter 26 is initialised with the maximum number of replacements authorised and is capable of being decreased, on a command from the monitoring means 24, each time the LLI broadcast zone information stored in the memory 20 is replaced by a different GLI broadcast zone information contained in the signal.

The monitoring means 24 is connected to the selection means 28 constituted, for example, by a remote control or selection switches to allow the user to authorise or refuse the last possible replacement of the LLI broadcast geographic zone information recorded in the memory 20 by the GLI broadcast geographic zone information contained in the decoded signal, as will be explained in the rest of the description.

When operating, during a stage 42 shown in FIG. 2, the reception means 10 of the decoder unit receives a display signal, for example in MPEG 2 format, by the transmission line 12.

Then, this display signal is transmitted to the decoding means 13.

During a stage 44, the decoding means 13 decode the display signal. The signal thus decoded still contains the GLI broadcast geographic zone information.

The decoding means 13 can also communicate with the server of the audiovisual content provider when the audiovisual content is paying, encrypt the display signal according to a format specific to the internal network and possibly, for a domestic network, transform the protocol of the signal of a long distance network type into a protocol of a short distance network type (LAN Local Array Network) and/or convert the digital signal into an analogue signal, when the television set 6 is an analogue television set.

During a step 46, the transmission means 11 transmits the display signal and the GLI information contained in this signal to the television set 6, by the channel 4.

Then, during a step 48, the connection means 14 receives this signal.

During a step 50, the reading means 18 reads or extracts the broadcast geographic zone information GLI from the decoded display signal and transmits one part, this GLI information, to the comparison means 22 and on the other hand, the audiovisual content to the monitoring means 24.

During a step 52, the comparison means 22 compares the GLI broadcast geographic zone information read by the reading means 18, to the LLI geographic zone information recorded in the memory 20.

When no LLI geographic zone information is recorded in the memory 20 as in, for example, the first use of the television set 6, the comparison means 22 sends the monitoring means 24 a validation signal representative of an agreement between the GLI and LLI information.

When the LLI information stored corresponds to the information from the GLI signal, the comparison means 22 sends a validation signal to the monitoring means 24. On receiving this validation signal, the monitoring means 24 sends the audiovisual content to the presentation means 15 during step 54.

After displaying this content, the method goes to step 48, during which the connection means 14 waits for the reception of the new decoded signal.

When the LLI stored information does not correspond to the GLI information from the signal, the comparison means 22 sends a non-validation signal to the monitoring means 24, and the method goes to step 56.

During this step 56, the monitoring means 24 consults the counter 26 to determine whether the number of authorised replacements remaining RLC is greater than 1.

When this RLC number is greater than 1, the monitoring means 24 transmits a pulse to the counter 26 so that the counter decreases the RLC number, during a step 58. In parallel, the monitoring means 24 sends the GLI information coming from the signal to the memory 20 and replaces the previously stored LLI information with the GLI information coming from the signal.

Next, the monitoring means 24 transmits the audiovisual content received by the reading means 18 to the display means 15, during the step 54.

When the LLI broadcast zone information stored in the memory 20 is a complex geographic zone code, like for example the code “EP” for Europe, and the signal comprises a simple GLI geographic zone code corresponding to a country in Europe, such as the code “DE” fro Germany, the RLC is not decreased.

When the LLI broadcast zone information stored in the memory 20 is a simple geographic zone code from a country in Europe, such as the code “IT” for Italy and the signal comprises a complex GLI geographic zone code corresponding to Europe, the RLC is not decreased. In this case the LLI information stored in the memory 20 remains the simple geographic zone code “IT”. This LLI information is not replaced by the complex code corresponding to Europe.

When the RLC number is not greater than 1, the monitoring means 24 checks whether this number is equal to 1 during a step 60.

When this number is not equal to 1, and therefore it is equal to 0, the LLI information recorded in the memory 20 can no longer be replaced. In this case, the supervision module 24 sends a message to the presentation means 15 during a step 62 informing the user that the contents of the display signal cannot be displayed, as the GLI broadcast zone of this signal does not match the LLI broadcast zone stored in the television set.

Next, the procedure returns to the step 48 during which the connection means 14 waits for the reception of a new display signal.

When the RLC number is equal to 1, the monitoring means 24 sends an information message to the display means 15 during a step 64. This message warns the user that there remains only one more possibility of replacing the information of the LLI authorised broadcast zone information recorded in the memory 20 and proposes three options.

According to option a), the LLI broadcast zone information recorded in the memory 20 is replaced by the GLI broadcast zone information coming from the signal. The user now no longer has the possibility of replacing this information again.

According to option b), the LLI broadcast zone information recorded in the memory 20 is not replaced and the user cannot display the content of the decoded display signal.

According to option c), the choice of the user is deferred and the content of the decoded display signal is not displayed.

When the user selects option a) using the selection means 28, the monitoring means 24 sends, during a step 66, a pulse to the counter 26 that decreases the RLC number so that it is zero.

In parallel, the monitoring means 24 records the GLI broadcast information coming from the signal in the memory 20 by replacing the LLI broadcast zone information previously stored, during a step 66.

Then during the step 52, the comparison means 22 verifies the correspondence between the GLI broadcast zone information coming from the decoded display signal and the LLI broadcast zone information recorded in the memory 20. As this information is identical following step 66, the comparison means 22 sends a validation signal to the monitoring means 24 which transmits the audiovisual content to the display means 15, during the step 54.

When the user selects option b) or c) using the selection means 28, the RLC number in the counter 26 and the LLI information recorded in the memory 20, are not modified and the monitoring means 24 sends the display means 15 a message during the step 62 informing the user that he cannot view the content of the decoded display signal.

As a variant, the presentation device 6 is a loudspeaker. In this case the display signal is an audio signal played by the presentation means.

As a variant, the access device 2 is an optical disk drive broadcasting on the digital channel 4 data read on a disk, notably a DVD (acronym for “digital versatile disk”) or a digital recording device or even a computer adapted to receive data from a packet transmission network (Internet) through real-time downloads, namely by displaying the content as it is downloaded.

As a variant, the access device 2 comprises a module suitable for inserting a GLI authorised broadcast zone information element into the signal representing the content. This broadcast zone corresponds for example to the geographic zone where the access device was sold. This access device module can also receive the GLI information in a license containing the content access rights, the license being sent separately from the content within the framework of a rights management system known as DRM (Digital Rights Management).

As a variant, the audiovisual signal sent by the content providers is encoded and the monitoring means 24 of the television set 6 is suitable for decoding it, if the GLI zone information of the signal agrees with the LLI zone information recorded in the memory 20 or if the maximum number of authorised geographic zone changes is not reached.

1-10. (canceled)

11. Device for presentation of a signal containing an audiovisual contents comprising
means for presentation of the content,
means for connection to a transmission channel external to the device, for reception of the signal, and
a module for transmission of the signal . mounted in the same container as the presentation means and comprising means for storage of a first identification information, the transmission module being adapted to receive the signal from the connection means and to transmit it to the presentation means only if the first identification information agrees with a second identification information contained in the signal.

12. Device according to claim 11, wherein the second identification information comprises an authorised broadcast geographic zone information.

13. Device according to claim 11, wherein the second identification information contained in the signal received by the presentation device is protected against any modification.

14. Device according to claim 11 wherein the first identification information stored in the transmission module comprises the second identification information contained in the signal previously presented by the presentation means.

15. Device according to claim 11 wherein the module for transmission further comprises:
means for reading the second identification information contained in the signal,
means for comparing the first identification information with the second identification information, and
means for monitoring adapted to transmit to the presentation means the signal received by the connection means, when the first identification information agrees with the second identification information.

16. Device according to claim 15, wherein the monitoring means is adapted to replace, a set number of times, the first identification information by the second identification information when these elements of information do not match.

17. Device according to claim 16, wherein . before the last replacement, the monitoring means is adapted to send to the presentation means a message containing a selection request between on the one hand, a last replacement of the first identification information and, on the other, the non-replacement of this first identification information.

18. Device according to claim 16 wherein, after the last replacement, the monitoring means is adapted to send to the presentation means a message informing the user that the content of the signal cannot be viewed when the second identification information does not match the first identification information.

19. Presentation system of a signal containing an audiovisual content, the system comprising an access device, a transmission channel of which one extremity is connected to the access device, and a presentation device according to claim 1 connected to the other extremity of the transmission channel, wherein:
the access device comprises means for signal reception, means for signal decoding adapted to generate a decoded signal and means for sending the decoded signal to the presentation device, by means of the transmission channel, and
the presentation device is adapted to receive the decoded signal transmitted by the access device.

20. System according to claim 19, wherein the decoding means is adapted to preserve the second identification information contained in the signal or for reintroducing this information after extracting this information for transmission of this information to the presentation device.

21. Method of presenting a signal comprising an audiovisual content, comprising the steps of:
decoding the signal by an access device, and
transmitting the decoded signal to the access device to connection means of a presentation device, by a transmission channel external to the presentation device,
transmitting the decoded signal of the connection means to presentation means contained in the presentation device, only if a second identification information contained in the signal agrees with a first identification information stored in a storage means of the presentation device, and
displaying the signal audiovisual content by the presentation means of the presentation device where the transmission occurs during the previous stage.
